(19) United States
(12) Patent Application Publication
(10) Pub. No.: US 2015/0032464 A1
(43) Pub. Date: Jan. 29, 2015

(54) INTEGRATING THERANOSTICS INTO A CONTINUUM OF CARE

(71) Applicant: General Electric Company, Schenectady, NY (US)

(72) Inventor: Guy Robert Vesto, Barrington, IL (US)

(73) Assignee: General Electric Company, Schenectady, NY (US)

(21) Appl. No.: 13/952,309

(22) Filed: Jul. 26, 2013

(51) Int. Cl. G06F 19/00

(52) U.S. Cl. CPC G06F 19/3431; G06F 19/3418; G06F 19/345
USPC 705/2

(57) ABSTRACT

Methods, apparatus, systems and articles of manufacture to integrate theranostics into a continuum of care are disclosed herein. An example method includes generating a diagnostic interpretation based on patient information and recommending a theranostic therapy approach based on the diagnostic interpretation, the patient information and theranostics information. The example method further includes generating a portion of a therapeutic plan for a patient based on the theranostic therapy approach and determining a parameter of the patient to monitor based on the therapeutic plan. The example method also includes recommending a biosensor specification based on the parameter.

### BACKGROUND

Theranostics or personalized medicine has potential to reduce the costs of medical care and improve clinical outcomes. At this time, comparative effectiveness research is limited and payers such as insurance companies are hesitant to reimburse initial costs of theranostics such as genetic tests. However, costs of gene sequencing and genetic testing are falling and new theranostic therapies are emerging. For example, recently developed biosensors can be used to detect biomarkers associated with diseases such as cancer, and these biomarkers can be used to personalize treatment of the disease of an individual patient.

### SUMMARY

An example system includes a theranostics advisor to analyze patient information and recommend a theranostic therapy approach based on the patient information. The example system also includes a theranostics planner to generate a portion of a therapeutic plan for the patient based on the theranostic therapy approach. The example system further includes a biosensor advisor to recommend a biosensor specification based on the therapeutic plan and a patient monitor to receive biosensor information from a biosensor having the biosensor specification. The example system also includes a dashboard generator to generate a dashboard to display the biosensor information. A processor is to implement at least one of the theranostics advisor, the theranostics planner, the biosensor advisor, the patient monitor or the dashboard generator.

An example method disclosed herein includes generating a diagnostic interpretation based on patient information and recommending a theranostic therapy approach based on the diagnostic interpretation, the patient information and theranostics information. The example method further includes generating a portion of a therapeutic plan for a patient based on the theranostic therapy approach and determining a parameter of the patient to monitor based on the therapeutic plan. The example method also includes recommending a biosensor specification based on the parameter.

A tangible machine readable storage medium disclosed herein includes instructions that, when executed, cause a machine to at least suggest a theranostic therapy approach based on a clinical report associated with a patient and generate an inspection plan for the patient based on the clinical report and the theranostic therapy approach. The example instructions further cause the machine to determine a biosensor specification based on the inspection plan and monitor biosensor information generated via a biosensor employed by the patient. The biosensor is to have the biosensor specification.

### BRIEF DESCRIPTION OF THE DRAWINGS

FIG. 1 is a flow diagram representative of an example continuum of care for a patient.

FIG. 2 is a block diagram of an example cloud computing system disclosed herein, which may be used to integrate theranostics into the example continuum of care of FIG. 1.

FIG. 3 is a block diagram illustrating the example system of FIG. 2 facilitating diagnosis of the patient.

FIG. 4 is a block diagram illustrating the example system of FIG. 2 facilitating development of a therapeutic plan for the patient.

FIG. 5 is a block diagram illustrating the example system of FIG. 2 facilitating treatment of the patient.

FIG. 6 is a block diagram illustrating the example system of FIG. 2 receiving biosensor information generated via biosensors employed by the patient.

FIG. 7 is a block diagram illustrating the example system of FIG. 2 generating a dashboard to display the biosensor information generated via the biosensors employed by the patient.

FIG. 8 is a block diagram illustrating information flow via the example system of FIG. 2 over the example continuum of care 100 of FIG. 1.

FIG. 9 is a flowchart representative of example machine readable instructions for implementing the example system of FIGS. 2-7.

FIG. 10 is a block diagram of an example processor platform capable of executing the instructions of FIG. 9 to implement the example system of FIG. 2.

The figures are not to scale. Wherever possible, the same reference numbers will be used throughout the drawing(s) and accompanying written description to refer to the same or like parts.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION

Integrating theranostics into a continuum of care is disclosed herein. Theranostics involves the combination of diagnostics and therapy to personalize treatment of a patient based on, for example, molecular features of a disease, predicted effects of treatment, and/or a response of the disease to the treatment. Research and technology related to theranostics are developing rapidly. As a result, clinicians may not be aware of the most recently developed theranostic therapy approaches, newfound biomarkers associated with a medical condition, technological developments related to biosensors, suitable biosensors specifications and/or other information related to theranostics.

The examples disclosed herein assist clinicians by providing suggestions and up-to-date information related to biomarkers, biosensors, theranostic therapy approaches and/or other information. The clinicians may use the information to diagnose a medical condition and develop a therapeutic plan for the patient employing theranostics. The examples disclosed herein may also enable clinicians to order and/or prescribe biosensors for the patient capable of monitoring a biomarker of the patient of interest to the clinicians. The examples disclosed herein enable the patient and/or a caregiver to use, for example, a mobile device to retrieve information generated by the biosensors and communicate the information to a computing system accessible to the clinicians. Thus, the clinicians may monitor the information and assess an efficacy of the treatment. The examples disclosed herein also facilitate sharing and/or integration of information across different clinical information systems to enable theranostics to be utilized throughout the continuum of care of the patient. In some examples, third party users may access the computing system to contribute information to the computing system. For example, vendors and/or manufacturers of biosensors, pharmaceuticals and/or medical supplies may communicate product information to the computing system that is publishable to the clinicians and/or the patient.

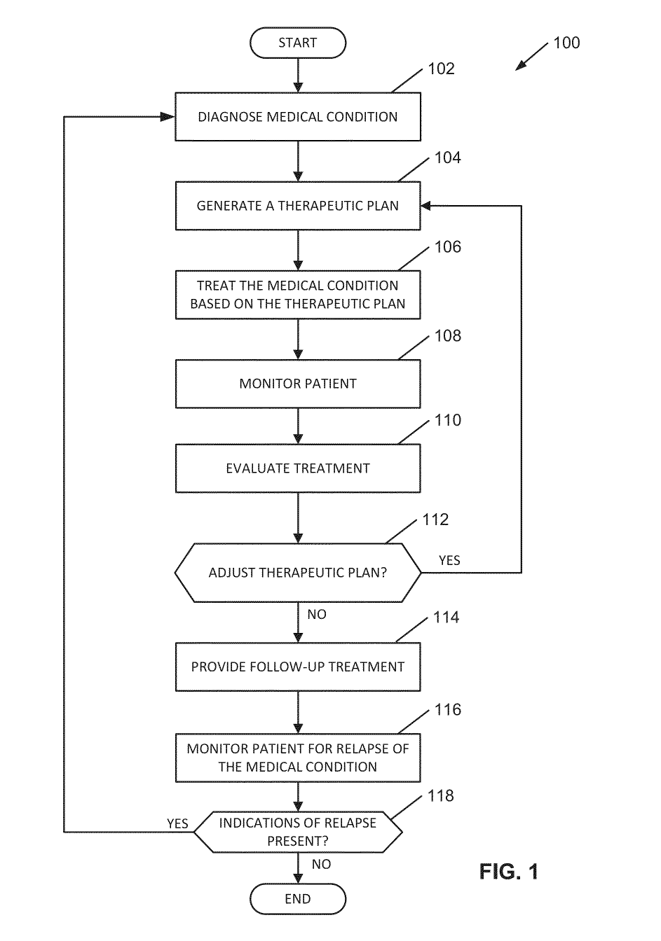

FIG. 1 is a flow diagram representative of an example continuum of care 100 for a patient. In the illustrated example, the continuum of care 100 includes diagnosing a medical condition of a patient (block 102). For example, a patient may present symptoms associated with cancer, and a biopsy is taken from the patient. A laboratory may conduct molecular level and/or genetic testing, and a pathologist may determine that the patient has a malignant tumor. A therapeutic plan for the patient is generated (block 104). In the illustrated example, the therapeutic plan includes one or more theranostic approaches in which the patient is to be treated based on biomarkers of the patient (as opposed to a generic or one-size-fits-all approach to treat the medical condition). Biomarkers are parameters that may be used to detect a state of a medical condition and/or an effect of treatment on the medical condition.

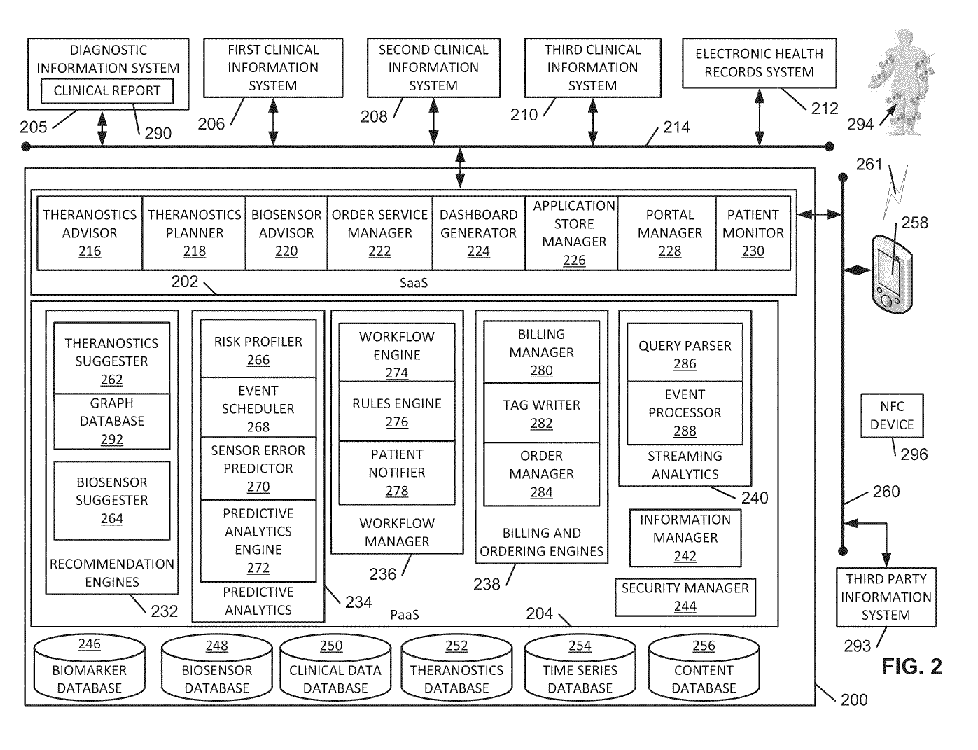

The patient is treated based on the therapeutic plan (block 106). For example, the patient may undergo chemotherapy. The patient is monitored (block 108). In some examples, the patient employs one or more biosensors to enable a clinician to monitor the patient. For example, the biosensors may communicate information associated with one or more biomarkers of the patient to a cloud computing system 200 (FIG. 2). In some examples, the patient is monitored after the patient is discharged from a medical facility and/or located outside the medical facility. For example, the patient and/or a caregiver may employ a mobile device (e.g., a smart phone, a wearable computer, a tablet, and/or any other mobile device) to acquire information from the biosensors and communicate the information to the cloud computing system 200 while the patient is at his or her home and/or at any other location. In some examples, the patient is monitored while the patient is within a medical facility such as a clinic, a hospital, a long-term care facility, etc. For example, the patient and/or a caregiver may employ a mobile device (e.g., a smart phone, a wearable computer, a tablet, and/or any other mobile device) to acquire information from the biosensors and communicate the information to the cloud computing system 200 while the patient is staying and/or located in the medical facility. The caregiver may be, for example, a clinician, a nurse, a pharmacist, a physician's assistant, and/or any other caregiver or provider.

The clinician may access the cloud computing system 200 and view the biosensor information to monitor the patient. Treatment of the patient is evaluated (block 110). For example, based on the biosensor information, the clinician may evaluate the efficacy of the treatment, for example, by analyzing trends in the biosensor information to determine if the patient has an increase in drug resistant cells. It is determined if the therapeutic plan is to be adjusted (block 112). If the therapeutic plan is to be adjusted, the example continuum of care 100 returns to block 104. If the therapeutic plan is not to be adjusted, follow-up treatment is provided to the patient (block 114). Once the medical condition of the patient is substantially cured (e.g., the patient is cancer free), the example continuum of care 100 of FIG. 1 includes monitoring the patient for relapse of the medical condition (block 116). It is determined if indications of relapse are present (block 118). If indications of relapse are present (e.g., if the patient presents symptoms of the medical condition, if information from one or more biosensors employed by the patient indicate that the medical condition has returned, etc.), the example continuum of care 100 returns to block 102.

FIG. 2 illustrates an example cloud computing system 200 to integrate theranostics into the example continuum of care 100 of FIG. 1. In the illustrated example, the system 200 includes a Software-as-a-Service (SaaS) layer 202 and a Platform-as-a-Service (PaaS) layer 204. Other examples employ other types of computing models. In the illustrated example, a diagnostic information system 205, a first clinical information system 206, a second clinical information system 208, a third clinical information system 210, and an electronic health records system 212 are in communication with the system 200 via a first bus 214. For example, the diagnostic information system 205 may be employed by a laboratory that conducts genetic and/or molecular testing. The example first clinical information system 206 may be an information system employed by a pathologist. The example second clinical information system 208 may be an information system employed by an oncologist. The example third clinical information system 210 may be employed by a radiologist. In other examples, the system 200 is in communication with different and/or additional information and/or records systems.

In the illustrated example, the Software-as-a-Service layer 202 includes a theranostics advisor 216, a theranostics planner 218, a biosensor advisor 220, an order service manager 222, a dashboard generator 224, an application store manager 226, a portal manager 228, and a patient monitor 230.

The example PaaS layer 204 includes recommendation engines 232, predictive analytics 234, a workflow manager 236, billing and ordering engines 238, streaming analytics 240, an information manager 242, and a security manager 244. The example system 200 also includes a plurality of databases and/or repositories such as, for example, a biomarker database 246, a biosensor database 248, a clinical data database 250, a theranostics database 252, a time series database 254 and a content database 256. Other examples include other databases. In the illustrated example, the PaaS layer 204 and/or the SaaS layer are in communication with the biomarker database 246, the biosensor database 248, the clinical data database 250, the theranostics database 252, the time series database 254 and the content database 256. Thus, the theranostics advisor 216, the theranostics planner, the predictive analytics 234, etc. may retrieve and/or employ information stored in the biomarker database 246, the biosensor database 248, the clinical data database 250, the theranostics database 252, the time series database 254, the content database 256 and/or any other database in communication with the example system 200. As described in greater detail below, the example system 200 is in communication with a mobile device 258 associated with the patient via a second bus 260 and/or a network communications system 261 such as the internet.

In the illustrated example, the recommendation engines 232 include a theranostics suggester 262 and a biosensor suggester 264. The example predictive analytics 234 of FIG. 2 includes a risk profiler 266, an event scheduler 268, a sensor error predictor 270, and a predictive analytics engine 272. The example workflow manager 236 of FIG. 2 includes a workflow engine 274, a rules engine 276, and a patient notifier 278. The example billing and ordering engines 238 include a billing manager 280, a tag writer 282, and an order manager 284. The example streaming analytics include a query parser 286 and an event processor 288. In other examples, the PaaS layer 204 includes other engines, analytics, managers and/or applications.

The example theranostics advisor 216 employs the theranostics suggester 262 to suggest and/or recommend a theranostic therapy approach for the patient. For example, the theranostics advisor 216 may receive patient information such as a clinical report 290 in graph format and/or including one or more graphs. The example theranostics advisor 216 of FIG. 2 employs the theranostics suggester 262 to process and/or analyze the patient information using a graph database 292, theranostics information from the theranostics database 252 and/or other information. Based on the patient information, the theranostics information and/or other information, the example theranostics advisor 216 suggests and/or recommends one or more theranostic therapy approaches for the patient. The example theranostics planner 218 generates an event schedule, an inspection plan and a workflow document of a therapeutic plan for the patient. In the illustrated example, the theranostics planner 218 employs the predictive analytics engine 272 and the event scheduler 268 to process and/or analyze the patient information, information stored in the biomarker database 246 and/or other information to determine the event schedule and generate the inspection plan for the patient based on the event schedule. In some examples, the event schedule is based on a risk profile of the patient. In the illustrated example, the theranostics planner 218 employs the risk profiler 266 to determine the risk profile of the patient. In some examples, the inspection plan includes Complex Event Processing (CEP) queries and rules that govern the patient monitor 230 and/or the patient notifier 278 to facilitate automation of information flow via the example system 200 to monitor the patient's medical condition via biosensor information and/or generate an alert to one or more clinicians based on the biosensor information. In the illustrated example, the rules are determined, selected and/or generated via the rules engine 276, and the query parser 287 manages queries. In the illustrated example, the theranostics planner 218 uses the workflow engine 274 to generate the workflow document. In some examples, the workflow document includes business process execution language scripts to automate one or more workflow tasks to be performed via the system 200.

The example biosensor advisor 220 employs the biosensor suggester 264 to determine monitoring parameters such as biomarkers associated with the patient's medical condition and suggests and/or recommends biosensors and/or biosensor specifications associated with the monitoring parameters. In some examples, the biosensor suggester 264 determines and/or recommends the monitoring parameters and/or the biosensor specifications based on the patient information, biosensor information from the biosensor database 248, the therapeutic plan and/or other information. In some examples, biosensor information stored in the biosensor database 248 is contributed by a third party user via a third party information system 293 in communication with the example system 200. For example, a biosensor manufacturer may communicate product information such as the biosensor specifications and/or other information to the system 200, and the product information is stored in the biosensor database 248. As described in greater detail below in conjunction with the order service manager 222, the application store manager 226, the portal manager 228 and the patient monitor 230, biosensors 294 having the biosensor specifications are ordered and employed by the patient to enable the system 200 to monitor the patient's medical condition and/or an efficacy of treatment administered to the patient.

The order service manager 222 recommends and/or manages an order to be requested by a clinician. In some examples, the order request includes one or more prescriptions for the pharmacy to fill for the patient. In some examples, the order request includes the biosensor specifications recommended by the biosensor advisor 220. In some examples, based on the biosensor specifications, the therapeutic plan and/or information such as the prescriptions, the order service manager 222 suggests and/or recommends biosensors to be employed by the patient in conjunction with therapeutics such as, for example, medications prescribed by the clinician, medical procedures (e.g., chemotherapy) the patient is to undergo, etc.

In some examples, the order request includes a tag associated with the patient. In some examples, the tag is represented via a barcode, which may be printed onto, for example, a bracelet to be worn by the patient while the patient is in a medical facility. In other examples, the tag is a near field communication (NFC) tag to be stored on an NFC device 296 to be issued to the patient by an NFC device dispensary. The order service manager 222 may enable the clinician to review the order and, if selected and/or approved by the clinician, the order service manager 222 communicates an order request to, for example, a pharmacy, the application store manager 226, and/or the NFC device dispensary (e.g., a clinic, a hospital, a pharmacy, etc.). In the illustrated example, the order service manager 222 employs the tag writer 282 to write, generate and/or print the tag. As described in greater detail below, the tag may be scanned or read by the mobile device 258 and communicated to the portal manager 228 to enable the patient and/or a caregiver to access a biosensor marketplace to order the biosensors 294.

The example application store manager 226 manages the biosensor marketplace. For example, the application store manager 226 may filter biosensors available to the patient and/or the caregiver via the biosensor marketplace based on the biosensor specifications recommended by the biosensor advisor 220. In some examples, the application store manager 226 transmits an application to the mobile device 258 associated with the patient. As referred herein, a mobile device associated with the patient is a mobile device employed by the patient and/or a caregiver of the patient (e.g., a clinician, a nurse, and/or any other caregiver of the patient). The application may be generated (e.g., written) by the third party user and contributed or submitted to the example system 200 via the third party information system 293 and/or any other third party information system in communication with the example system 200. The mobile device 258 may run the application to enable the mobile device 258 to read the tag (e.g., a tag represented via a barcode, the NFC tag from the NFC device 296, etc.) and/or access the biosensor marketplace. In some examples, in response to receiving the order request from the order service manager 222, the application store manager 226 generates a universal resource identifier (URI) such as a universal resource locator (URL) associated with the patient. As a result, when the mobile device 258 communicates the tag to the portal manager 228, the portal manager 228 directs the mobile device 258 to the URL by, for example, generating a link to the URL and communicating the link to the mobile device 258. Biosensors available to be ordered by the patient and/or the caregiver via the URL have the biosensor specifications. Thus, the patient and/or the caregiver is prevented from ordering biosensors via the example system 200 having specifications that fall outside of the biosensor specifications recommended by the biosensor advisor 220.

In the illustrated example, the order service manager 222 and/or the application store manager 226 employ the billing manager 280 and the order manager 284 to determine and/or process billing information and/or order information to enable a barcode including a tag to be generated and/or printed, the NFC device 296 including a tag to be issued to the patient, the prescription(s) to be filled, the biosensors 294 to be ordered and received by the patient and/or the caregiver, etc. In other examples, the billing manager 280 and/or the order manager 284 perform other billing and/or ordering services.

The patient monitor 230 of the example system 200 of FIG. 2 receives and/or processes biosensor information from the biosensors 294. For example, once the biosensors 294 are administered (e.g., applied, worn, ingested, injected, etc.) to and/or by the patient, the mobile device 258 receives biosensor information and communicates the biosensor information to the patient monitor 230. In some examples, the biosensor information is stored in the time series database 254 and/or the content database 256. In some examples, the patient monitor 230 organizes the biosensor information by, for example, generating graphs charts, etc. based on the biosensor information.

In some examples, the patient monitor 230 determines if the biosensor information indicates one or more events. In the illustrated example, the patient monitor 230 utilizes a sensor error predictor 270 and an event processor 288 to determine if the biosensors 294 are functioning properly and/or if an alert is to be provided to a clinician via the dashboard generator 224 and/or the patient and/or the caregiver via the mobile device 258. For example, the event processor 288 may determine if one or more of the monitoring parameters of the patient is within a predetermined range of values. If the monitoring parameter(s) are outside of the predetermined range of values, the patient monitor 230 may cause the dashboard generator 224 to generate an alert on a clinician dashboard and/or communicate an alert to the mobile device 258. More specifically, in some examples, the patient monitor 230 determines if the biosensors 294 are administered properly, if the biosensors 294 are in communication with the mobile device 258, if the biosensors 294 are removed from the patient (e.g., if a biostamp is washed or rubbed off the patient, if a garment including the biosensors 294 is no longer being worn by the patient, etc.), if the biosensors 294 are communicating information within an expected or predetermined time frame(s), if an integrity of the information communicated by the biosensors 294 is compromised, etc. In the illustrated example, the patient monitor 230 employs the patient notifier 278 to communicate alerts and/or information to the mobile device 258 related to the biosensors 294 and/or the patient's medical condition. In some examples, the patient notifier 278 pushes alerts and/or notifications to the mobile device 258.

The example portal manager 228 of FIG. 2 may employ the security manager 244 to manage security and/or privacy settings of the system 200. For example, the patient portal generator 228 may prevent the mobile device 258 from accessing portions of the system 200 unless the mobile device 258 communicates the tag generated by the tag writer 282. In some examples, the security manager 244 may limit which information is available between the diagnostics information system 205, the first clinical information system 206, the second clinical information system 208, the third clinical information system 210, and/or the electronic health records system 212 via the example system 200. In some examples, the security manager 244 supports compliance with privacy laws or rules such as The Health Insurance Portability and Accountability Act of 1996 (HIPAA).

In some examples, the portal manager 228 enables third party users such as vendors and/or manufacturers of biosensors, pharmaceuticals and/or medical supplies and/or other third party users to communicate information to the example system 200. For example, the portal manager 228 may enable a biosensor manufacturer to store product information such as biosensor specifications in the biosensor database 248 via the third party information system 293 and/or any other third party information system 293 in communication with the example system 200. In some examples, the application store manager 226 may update, for example, biosensors available to the patient via the biosensor marketplace based on the product information communicated to the system 200 via the third party information system 293. The product information may also be received from the third party information system 293 and published to the clinician(s) via a dashboard and/or to the patient and/or caregiver via the mobile device 258. In some examples, applications to be run via the mobile device 258 are communicated to the system 200 via the third party information system 293.

In some examples, the portal manager 228 enables the third party users to communicate product information such as advertisements to the example system 200. The application store manager 226 may publish the advertisements to the patient and/or caregiver when the biosensor marketplace is accessed via the mobile device 258. In some examples, the advertisements are published to the clinician(s) via the dashboard generated by the dashboard generator 224. In some examples, the advertisements advertise the product information and/or the applications that may be ran via the mobile device 258.

The third party users, product information related to biosensors and advertisements noted above are merely examples. Thus, other third party users communicate other types of information to the system in other examples. For example, a research organization may communicate medical information such as a medical journal article to the system 200 via the third party information system 293.

In some examples, the portal manager 228 enables the third party users to view and/or retrieve information via the system 200. For example, the portal manager 228 may enable the third party users to retrieve biomarker information stored in the biomarker database 246, biosensor information stored in the biosensor database 248, and/or other information via, for example, a dashboard generated via the dashboard generator 224. In some examples, the security manager 244 limits which information is available to the third party users. For example, the security manager 244 may prevent the third party users from accessing patient information.

The example information manager 242 formats, translates, integrates, processes and/or organizes information communicated between the system 200 and the diagnostic information system 205, first clinical information system 206, the second clinical information system 208, the third clinical information system 210, the electronic health records system 212, the third party information system 293 and/or the mobile device 258 to facilitate information flow within, to and/or from the example system 200. In some examples, the information manager 242 employs terminology mapping, data ingestion, and/or semantic parsers.

In the illustrated example, the dashboard generator 224 generates one or more clinician dashboards, which may be viewed via the diagnostic information system 205, the first clinical information system 206, the second clinical information system 208, the third clinical information system 210 and/or the electronic health records system 212. The clinician dashboards may include information related to the patient's medical condition(s) and/or the biosensors 294. For example, the clinician dashboards may include one or more graphs, charts, tables, and/or diagrams including the biosensor information generated via the biosensors 294 to enable one or more clinicians to monitor the patient's medical condition, determine an efficacy of the treatment, etc. In some examples, the dashboard generator 224 generates one or more alerts on the clinician dashboards to notify the clinician(s) of information related to the patient's medical condition and/or the biosensors 294. In some examples, the dashboard generator 224 generates one or more third party dashboards, which may be viewed via the third party information system 293 in communication with the example system 200.

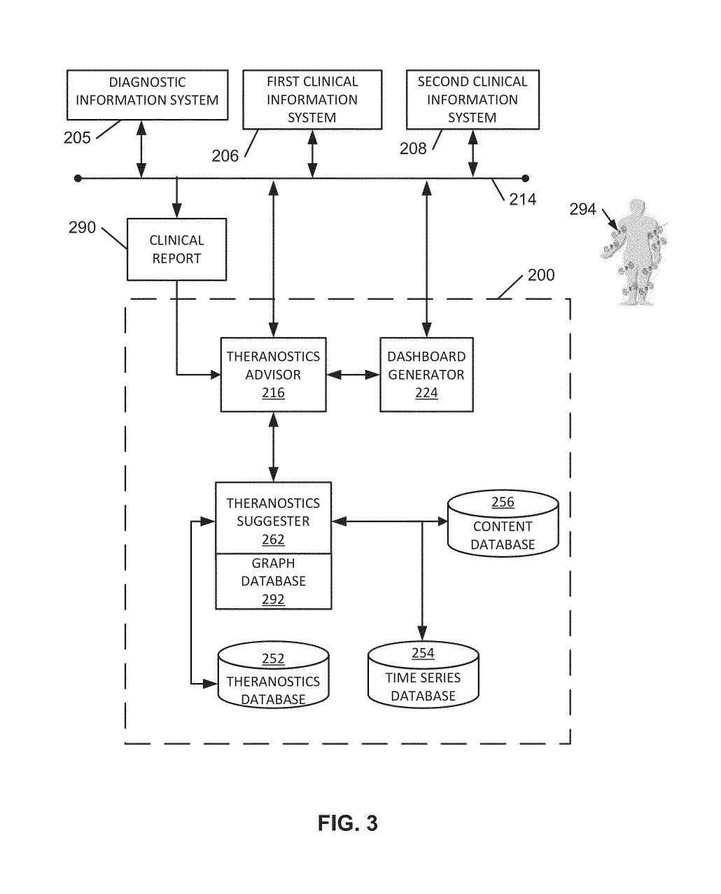

FIG. 3 is a block diagram illustrating the example system 200 of FIG. 2 facilitating diagnosis of the patient in the example continuum of care 100 of FIG. 1. While the example continuum of care 100 is described in the context of diagnosing and/or treating cancer in the following examples, the example methods, systems, apparatus, and articles of manufacture disclosed herein may be used to integrate theranostics into the continuum of care 100 for any medical condition.

In the illustrated example, the theranostics advisor 216 employs the theranostics suggester 262 and the theranostics database 252 to process and/or analyze patient information to provide diagnostic interpretations and/or suggest one or more theranostic therapy approaches for the patient. For example, a clinician may suspect the patient has cancer based on symptoms exhibited and/or presented by the patient. As a result, a biopsy may be taken from the patient and analyzed by a laboratory employing the diagnostic information system 205. In the illustrated example, the laboratory conducts molecular and/or genetic testing and generates the clinical report 290. In some examples, the clinical report 290 is a pathology report. In other examples, other types of reports are generated. In some examples, the clinical report 290 may include results of the molecular and/or genetic testing in graph format. In some examples, the diagnostic information system 205 transmits the clinical report 290 to the first clinical information system 206 via the first bus 214. In some examples, the clinical report 290 is stored in the content database 256 and/or any other database. A pathologist using the first clinical information system 206 may retrieve and/or view the clinical report 290 via a clinician dashboard generated by the dashboard generator 224.

In some examples, the theranostics advisor 216 receives and/or processes the clinical report 290 and/or information from the clinical report 290. In some examples, the theranostics advisor 216 also receives and/or processes information from the first clinical information system 206, the second clinical information system 208, the third clinical information system 210, and/or the electronic health records system 212. For example, the theranostics advisor 216 may receive and/or process information from a chromosome analysis, a molecular hempathological analysis, a molecular solid tumor analysis, and/or other information. The example theranostics advisor 216 employs the theranostics suggester 262 to process and/or analyze information in the clinical report 290 and/or other information using the graph database 292. Based on the information, the theranostics advisor 216 may generate diagnostic interpretations of the information and/or recommend a theranostic therapy approach for the patient. In some examples, the diagnostic interpretation(s) are used by the pathologist to diagnose the patient's medical condition and/or generate a synoptic report for an oncologist that includes the recommended theranostic therapy approach. In the illustrated example, the oncologist may view the clinical report 290 and/or the synoptic report via a dashboard generated via the dashboard generator 224.

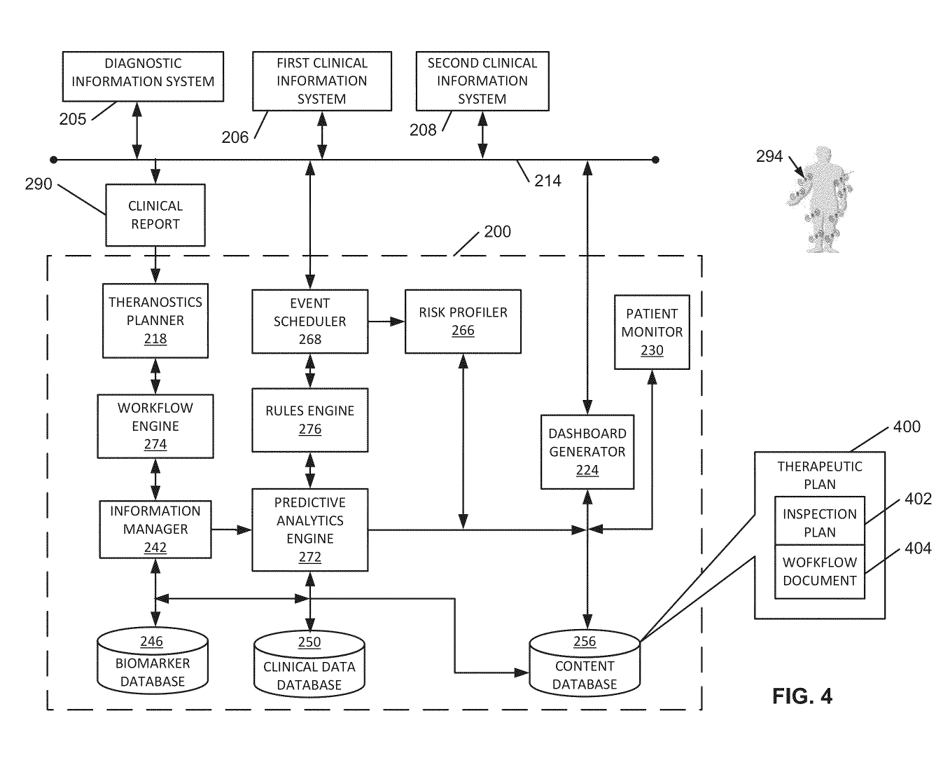

FIG. 4 is a block diagram illustrating the example system 200 of FIG. 2 facilitating development of a therapeutic plan 400 for the patient in the example continuum of care 100 of FIG. 1. In the illustrated example, the oncologist uses the example system 200 to generate the therapeutic plan 400 for the patient based on the synoptic report. The example therapeutic plan 400 of FIG. 4 includes an inspection plan 402 and a workflow document 404. In the illustrated example, the theranostics planner 218 uses the predictive analytics engine 272 and the event scheduler 268 to process and/or analyze the clinical report 290, the synoptic report, information stored in the biomarker database 246 and/or other information to determine an event schedule and generate the inspection plan 402 based on the event schedule. In some examples, the event schedule is based on a risk profile of the patient. In the illustrated example, the risk profiler 266 determines the risk profile based on the clinical report 290. In the illustrated example, the inspection plan 402 includes Complex Event Processing (CEP) queries and rules used by the patient monitor 230. In the illustrated example, the rules are determined, selected and/or generated via the rules engine 276. In the illustrated example, the theranostics planner 218 uses a workflow engine 274 to generate the workflow document 404. The example workflow document 404 of FIG. 4 includes Business Process Execution Language (BPEL) scripts.

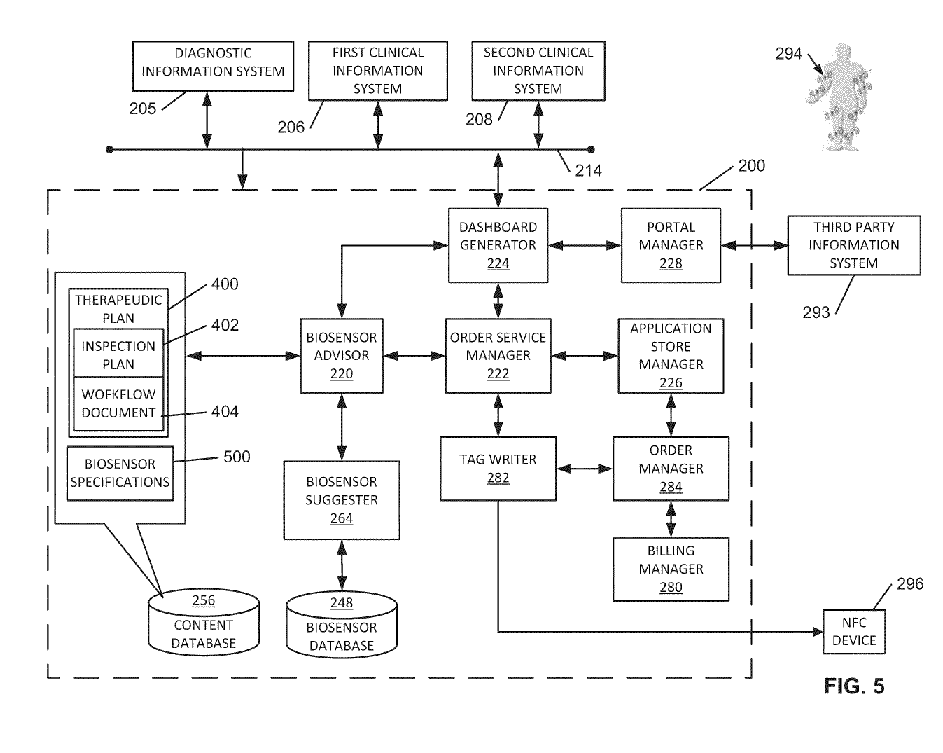

FIG. 5 is a block diagram illustrating the example system 200 of FIG. 2 facilitating treatment of the patient in the example continuum of care 100 of FIG. 1. The medical condition of the patient is treated based on the example therapeutic plan 400. For example, a physician may prescribe medication for the patient, a radiologist may administer one or more rounds of chemotherapy to the patient, and/or the medical condition of the patient may be treated in any other way. In the illustrated example, the system 200 facilitates the treatment of the patient by enabling the clinician to order prescriptions, provide the patient and/or the caregiver with access to the biosensor marketplace through which the patient and/or the caregiver may order biosensors and/or monitor an efficacy of the treatment.

The example order service manager 222 manages an order requested by a clinician. In some examples, the order service manager 222 may recommend one or more biosensors to be used by the patient based on the therapeutic plan, biosensor specifications, therapeutics and/or other information. In the illustrated example, the example biosensor advisor 220 employs the biosensor suggester 264 to determine monitoring parameters (e.g., biomarkers) associated with the patient's medical condition and/or the therapeutic plan 400 and suggests and/or recommends the biosensor specifications 500 based on the monitoring parameters and biosensor information such as biosensor specifications from the biosensor database 248. In some examples, the biosensor information is stored and/or published in the biosensor database 248 via the third party information system 293, which may be employed by a biosensor manufacturer and/or any other third party user. In the illustrated example, the biosensor specifications 500 are stored in the content database 256 and/or any other database. Based on these recommendations, the clinician may generate an order request including one or more prescriptions, the biosensor specifications and/or the biosensors 294.

The order service manager 222 may enable the clinician to review the order and, if selected and/or approved by the clinician, the order service manager 222 communicates the order request to, for example, a pharmacy, the application store manager 226, and/or a NFC device dispensary. In some examples, the order request includes a tag (e.g., a tag represented via a barcode, an NFC tag to be stored on the NFC device 296, and/or any other tag) to be issued to the patient. In the illustrated example, the order service manager 222 employs the tag writer 282 to write, generate and/or print the tag. In some examples, in response to receiving the order request from the order service manager 222, the application store manager 226 generates a universal resource locator (URL) associated with the patient. As described in greater detail below, the tag may be scanned or retrieved by the mobile device 258 and communicated to the portal manager 228 to enable the patient and/or the caregiver to access the biosensor marketplace via the URL to order the biosensors 294.

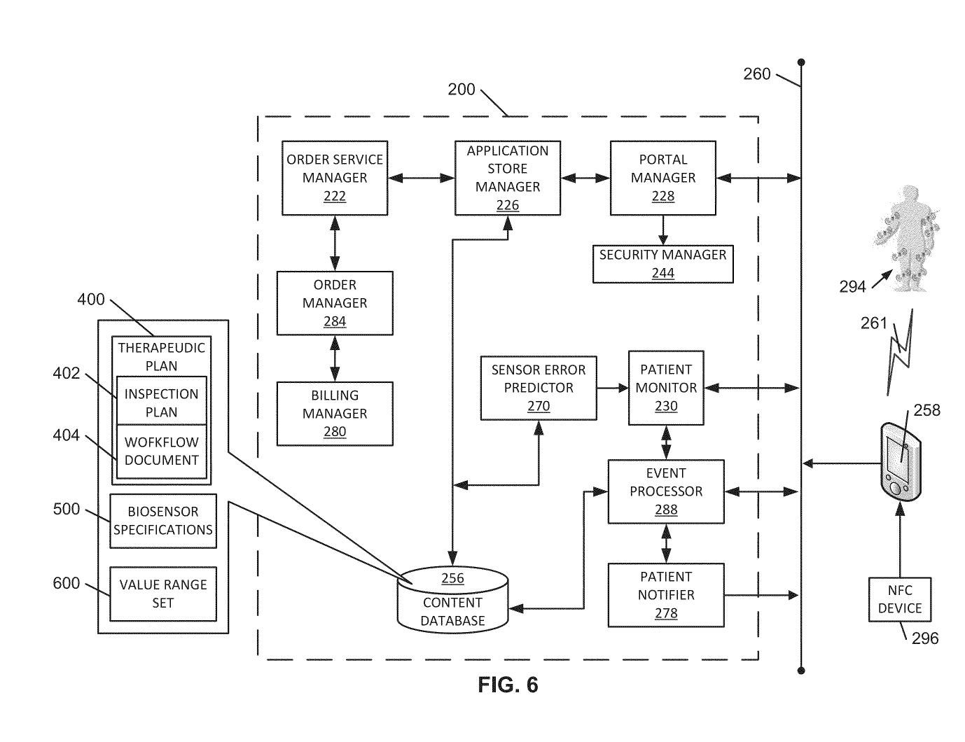

FIG. 6 is a block diagram illustrating the example system 200 of FIG. 2 receiving biosensor information generated via the biosensors 294 and communicating biosensor information to the mobile device 258 associated with the patient. For example, when the patient and/or a caregiver receives the NFC device 296, the patient and/or the caregiver may use the mobile device 258 to scan, retrieve and/or read the tag stored on the NFC device 296. The mobile device 258 may then communicate the tag to the application store manager 226 via a patient portal. In some examples, when the patient is issued a barcode including the tag, the patient and/or the caregiver may use the mobile device 258 to scan or read the barcode and communicate the tag to the application store manager 226. In some examples, the portal manager 228 generates the patient portal through which the patient and/or the caregiver may access the biosensor marketplace.

If the security manager 244 recognizes the tag, the application store manager 226 and/or the portal manager 228 communicates a monitoring application and/or the URL to the mobile device 258. In some examples, the mobile device 258 may run the monitoring application to enable the mobile device 258 to access the biosensor marketplace. In some example, advertisements and/or product information received from the third party information system 293 are published to the patient and/or the caregiver via the mobile device 258 when the mobile device 258 accesses the biosensor marketplace. The example application store manager 226 may filter biosensors available to the patient and/or the caregiver via the biosensor marketplace based on the biosensor specification 500 recommended by the biosensor advisor 220. As a result, biosensors available to be ordered by the patient and/or the caregiver via the biosensor marketplace have the biosensor specifications 500, and the patient and/or the caregiver is prevented from ordering biosensors having specifications that fall outside of the biosensor specifications 500 recommended by the biosensor advisor 220.

In the illustrated example, the patient and/or the caregiver orders the biosensors 294 via the biosensor marketplace. The biosensors 294 may be wearable sensors, intelligent garments, biostamps, ingestible sensors, “smart dust” sensors, and/or any other type of biosensor(s). In the illustrated example, the order service application 222 employs the order manager 284 and the billing manager 280 to process billing information and/or order information to enable the patient and/or the caregiver to order and receive the biosensors 294.

Once the patient and/or the caregiver receives the biosensors 294 and the biosensors 294 are administered (e.g., ingested, injected, worn, applied, etc.), the mobile device 258 may receive biosensor information communicated by the biosensors 294. In the illustrated example, the mobile device 258 communicates the biosensor information to the patient monitor 230. For example, the monitoring application received via the application store manager 226 enables the mobile device 260 to receive and/or process biosensor information communicated by the biosensors 294. In the illustrated example, the patient monitor 230 of the example system 200 receives and/or processes the biosensor information. In the illustrated example, the patient monitor 230 employs the sensor error predictor 270 to determine if the biosensors 294 are functioning properly. For example, in some examples, the patient monitor 230 determines if the biosensors 294 are administered properly, if the biosensors 294 are in communication with the mobile device 258, if the biosensors 294 are removed from the patient (e.g., if a biostamp is washed or rubbed off the patient, if a garment including the biosensors 294 is no longer being worn by the patient, etc.), if the biosensors 294 are communicating information within an expected or predetermined time frame(s), if an integrity of the information communicated by the biosensors 294 is compromised, etc.

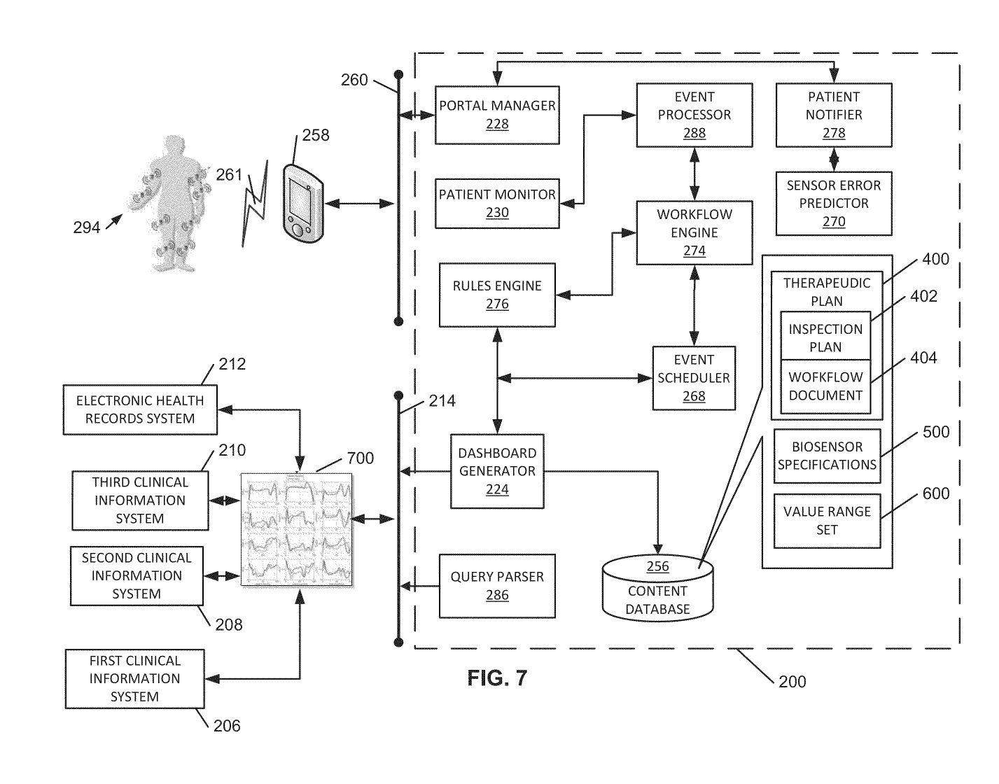

If the sensor error predictor 270 determines that the biosensors 294 are not functioning properly and/or may subsequently function improperly, the patient notifier 278 communicates an alert to the mobile device 258. For example, the patient notifier 278 may generate and transmit an e-mail to an e-mail address associated with the patient and/or the caregiver indicating, for example, that the biosensors 294 should be replaced. In some examples, the event processor 288 may determine if one or more of the monitoring parameters of the patient is within a predetermined range of values. The predetermined range of values may be listed in a value range set 600 stored in the content database 256. If the monitoring parameter(s) are outside of the predetermined range of values, the patient notifier 230 may communicate an alert to the mobile device 258. FIG. 7 is a block diagram illustrating the example system 200 of FIG. 2 generating a dashboard 700 to display the biosensor information generated via the biosensors 294 employed by the patient. In the illustrated example, alerts are generated based on the biosensor information and/or the inspection plan 402. For example, an alert may be generated via the dashboard 700 to notify a clinician to evaluate the treatment administered to the patient, and the clinician may retrieve the dashboard 700 via the system 200 to view the biosensor information. Based on the biosensor information, the therapeutic plan 400 may be may be adjusted via the theranostics planner 218 and the medical condition of the patient further monitored.

Once the medical condition of the patient is cured and/or in remission, the patient and/or the caregiver may use the mobile device 258 to order one or more additional and/or different biosensors. After the biosensors are administered to and/or by the patient, the example patient monitor 230 monitors the biosensor information generated by the biosensor and communicated to the patient monitor 230 via the mobile device 258. If the event processor 288 detects a relapse of the medical condition, the dashboard generator 224 may generate an alert via the dashboard 700, and/or the patient notifier 278 may communicate an alert to the mobile device 258.

In some examples, the patient monitor 230 communicates information to the mobile device 258 related to the medical condition of the patient. For example, the patient monitor 230 may transmit a link to a recent article from a medical journal related to the patient's medical condition. Thus, the example system 200 enables the patient and/or the caregiver to be informed regarding the medical condition to help the patient, for example, detect indications of relapse of the medical condition. In some examples, the information related to the medical condition is submitted or contributed to the example system by a third party user such as a research organization employing the example third party information system 293 and/or any other third party information system in communication with the example system 200.

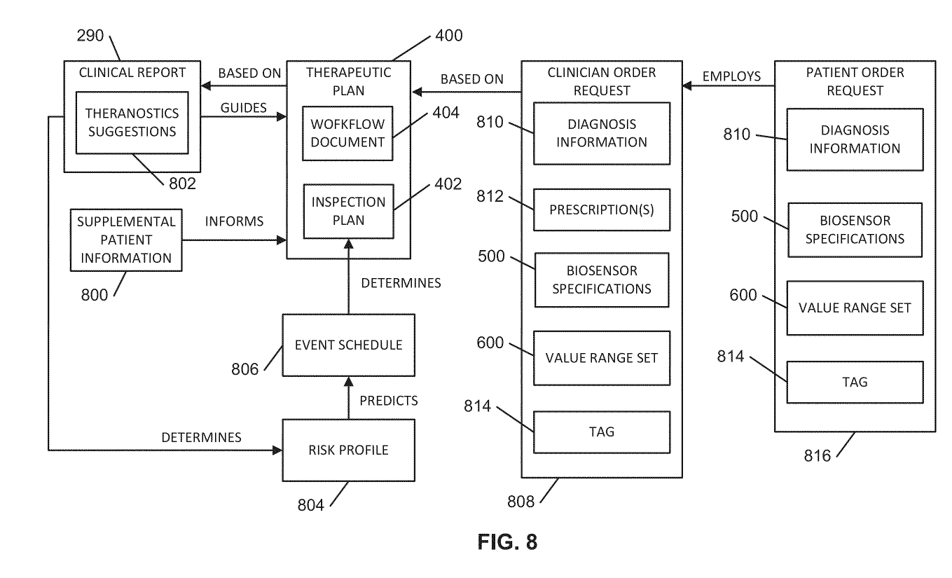

FIG. 8 is a block diagram illustrating information flow via the example system of FIG. 2 over the example continuum of care 100 of FIG. 1. In the illustrated example, the clinical report 290 and supplemental patient information 800 are used to diagnose the patient's medical condition. In some examples, the clinical report 290 is a genetic report, which may include theranostic suggestions 802. The example supplemental patient information 800 may include radiological images, a chromosome analysis, a molecular hempathological analysis, a molecular solid tumor analysis, and/or other information. In some examples, the clinical report 290 identifies the patient's medical condition and/or is used to diagnose the patient's medical condition.

In the illustrated example, the therapeutic plan 400 is generated based on the clinical report 290. For example, in some examples, a clinician generates the therapeutic plan 400 to treat the medical condition identified in the clinical report 290 using the theranostic suggestions 802 and/or based on the patient information 800. In some examples, a risk profile 804 of the patient is determined using the clinical report 290. In the illustrated example, the risk profile 804 is used to determine an event schedule 806 for the patient. Based on the example event schedule 806, the inspection plan 402 of the therapeutic plan 400 is determined. The example inspection plan 402 facilitates automation of information flow via the example system 200 to, for example, monitor the patient's medical condition via biosensor information and/or generate an alert to one or more clinicians based on the biosensor information. The example therapeutic plan 400 includes the workflow document 404 to facilitate automation of information flow through the example system 200 (FIG. 2) over the example continuum of care 100. For example, the workflow document 404 may include BPEL scripts to automate one or more workflow tasks to be performed via the system 200.

In the illustrated example, treatment of the patient's medical condition is based on the therapeutic plan 400. In the illustrated example, to treat the patient's medical condition, one or more clinicians generate a clinician order request 808 via the system 200 of FIG. 2 to enable the patient to receive one or more theranostic therapies. In the illustrated example, the clinician order request 808 includes diagnosis information 810, one or more prescriptions 812, the biosensor specifications 500, the value range set 600 and a tag 814. In some examples, the diagnosis information includes the patient's medical condition, a gene profile, and/or other information. The example prescriptions 812 may include prescriptions for medication, biosensors, therapies, etc. The example tag 814 is to be used by the patient and/or a caregiver to access the system 200 via the mobile device 258 (FIG. 2).

In the illustrated example, the patient is monitored using one or more biosensors. In some examples, the patient and/or the caregiver employs the mobile device 258 to communicate biosensor information to the example system 200 of FIG. 2. In some examples, the patient is monitored after the patient is discharged from a medical facility. For example, the patient and/or a caregiver may use the mobile device 258 to acquire information from the biosensors 294 and communicate the information to the cloud computing system 200 while the patient is at his or her home and/or at any other location. In some examples, the patient is monitored while the patient is within a medical facility such as a clinic, a hospital and/or a long-term care facility by a caregiver or provider. For example, a nurse may employ the mobile device 258 to acquire information from the biosensors 294 and communicate the information to the cloud computing system 200 while the patient is staying in the hospital. The provider or caregiver may be, for example, a clinician, a nurse, a pharmacist, a physician's assistant, and/or any other caregiver or provider. The example system 200 monitors the patient's medical condition based on the biosensor information and generates alerts based on the biosensor information and/or the inspection plan 402. In some examples, one or more clinicians may adjust the therapeutic plan 400 based on the biosensor information.

In some examples, the patient and/or the caregiver may generate a patient order request 816 to order biosensors via the example system 200 and enable the system 200 to monitor the patient. In some examples, the patient order request 816 employs information from the clinician order request 808 to enable the patient and/or the caregiver to order biosensors and/or receive information relevant to the patient's medical condition. For example, in the illustrated example, the patient order request 816 includes the diagnosis information 810, the biosensor specification 500, the value range set 600 and the tag 814, which the example system 200 may use to limit the biosensors available to the patient, generate rules to communicate alerts to clinicians, etc. In some examples, based on the patient order request 816, the system 200 communicates information related to the medical condition such as clinical research updates, medical advancement related to the medical condition, and/or other information requested by the patient.

While an example manner of implementing the cloud computing system 200 of FIG. 2 is illustrated in FIGS. 3-8, one or more of the elements, processes and/or devices illustrated in FIGS. 2-8 may be combined, divided, re-arranged, omitted, eliminated and/or implemented in any other way. Further, the example diagnostic information system 205, the example first clinical information system 206, the example second clinical information system 208, the example third clinical information system 210, the example electronic health records system 212, the example first bus 214, the example Software-as-a-Service layer 202, the example theranostics advisor 216, the example theranostics planner 218, the example biosensor advisor 220, the example order service manager 222, the example dashboard generator 224, the example application store manager 226, the example portal manager 228, the example patient monitor 230, the example Platform-as-a-Service layer 204, the example recommendation engines 232, the example predictive analytics 234, the example workflow manager 236, the example billing and ordering engines 238, the example streaming analytics 240, the example information manager 242, the example security manager 244, the example biomarker database 246, the example biosensor database 248, the example clinical data database 250, the example theranostics database 252, the example time series database 254, the example content database 256, the example mobile device 258, the example second bus 260, the example theranostics suggester 262, the example biosensor suggester 264, the example risk profiler 266, the example event scheduler 268, the example sensor error predictor 270, the example predictive analytics engine 272, the example workflow engine 274, the example rules engine 276, the example patient notifier 278, the example billing manager 280, the example tag writer 282, the example order manager 284, the example query parser 286, the example event processor 288, the example graph database 292, the example third party information system 293, the example biosensors 294, the example NFC device 296, the example therapeutic plan 400, the example inspection plan 404, the example workflow document 404, the example biosensor specification 500, the example value range set 600, the example dashboard 700, the example supplemental patient information 800, the example theranostic suggestions 802, the example risk profile 804, the example event schedule 806, the example clinician order request 808, the example diagnosis information 810, the example prescription(s) 812, the example tag 814, the example patient order request 816 and/or, more generally, the example cloud computing system 200 of FIG. 2 may be implemented by hardware, software, firmware and/or any combination of hardware, software and/or firmware. Thus, for example, any of the example diagnostic information system 205, the example first clinical information system 206, the example second clinical information system 208, the example third clinical information system 210, the example electronic health records system 212, the example first bus 214, the example Software-as-a-Service layer 202, the example theranostics advisor 216, the example theranostics planner 218, the example biosensor advisor 220, the example order service manager 222, the example dashboard generator 224, the example application store manager 226, the example portal manager 228, the example patient monitor 230, the example Platform-as-a-Service layer 204, the example recommendation engines 232, the example predictive analytics 234, the example workflow manager 236, the example billing and ordering engines 238, the example streaming analytics 240, the example information manager 242, the example security manager 244, the example biomarker database 246, the example biosensor database 248, the example clinical data database 250, the example theranostics database 252, the example time series database 254, the example content database 256, the example mobile device 258, the example second bus 260, the example theranostics suggester 262, the example biosensor suggester 264, the example risk profiler 266, the example event scheduler 268, the example sensor error predictor 270, the example predictive analytics engine 272, the example workflow engine 274, the example rules engine 276, the example patient notifier 278, the example billing manager 280, the example tag writer 282, the example order manager 284, the example query parser 286, the example event processor 288, the example graph database 292, the example third party information system 293, the example biosensors 294, the example NFC device 296, the example therapeutic plan 400, the example inspection plan 404, the example workflow document 404, the example biosensor specification 500, the example value range set 600, the example dashboard 700, the example supplemental patient information 800, the example theranostic suggestions 802, the example risk profile 804, the example event schedule 806, the example clinician order request 808, the example diagnosis information 810, the example prescription(s) 812, the example tag 814, the example patient order request 816 and/or, more generally, the example cloud computing system 200 of FIG. 2 can be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example diagnostic information system 205, the example first clinical information system 206, the example second clinical information system 208, the example third clinical information system 210, the example electronic health records system 212, the example first bus 214, the example Software-as-a-Service layer 202, the example theranostics advisor 216, the example theranostics planner 218, the example biosensor advisor 220, the example order service manager 222, the example dashboard generator 224, the example application store manager 226, the example portal manager 228, the example patient monitor 230, the example Platform-as-a-Service layer 204, the example recommendation engines 232, the example predictive analytics 234, the example workflow manager 236, the example billing and ordering engines 238, the example streaming analytics 240, the example information manager 242, the example security manager 244, the example biomarker database 246, the example biosensor database 248, the example clinical data database 250, the example theranostics database 252, the example time series database 254, the example content database 256, the example mobile device 258, the example second bus 260, the example theranostics suggester 262, the example biosensor suggester 264, the example risk profiler 266, the example event scheduler 268, the example sensor error predictor 270, the example predictive analytics engine 272, the example workflow engine 274, the example rules engine 276, the example patient notifier 278, the example billing manager 280, the example tag writer 282, the example order manager 284, the example query parser 286, the example event processor 288, the example graph database 292, the example third party information system 293, the example biosensors 294, the example NFC device 296, the example therapeutic plan 400, the example inspection plan 404, the example workflow document 404, the example biosensor specification 500, the example value range set 600, the example dashboard 700, the example supplemental patient information 800, the example theranostic suggestions 802, the example risk profile 804, the example event schedule 806, the example clinician order request 808, the example diagnosis information 810, the example prescription(s) 812, the example tag 814, the example patient order request 816 and/or, more generally, the example cloud computing system 200 of FIG. 2 is/are hereby expressly defined to include a tangible computer readable storage device or storage disk such as a memory, a digital versatile disk (DVD), a compact disk (CD), a Blu-ray disk, etc. storing the software and/or firmware. Further still, the example cloud computing system 200 of FIG. 2-8 may include one or more elements, processes and/or devices in addition to, or instead of, those illustrated in FIGS. 2-8, and/or may include more than one of any or all of the illustrated elements, processes and devices.

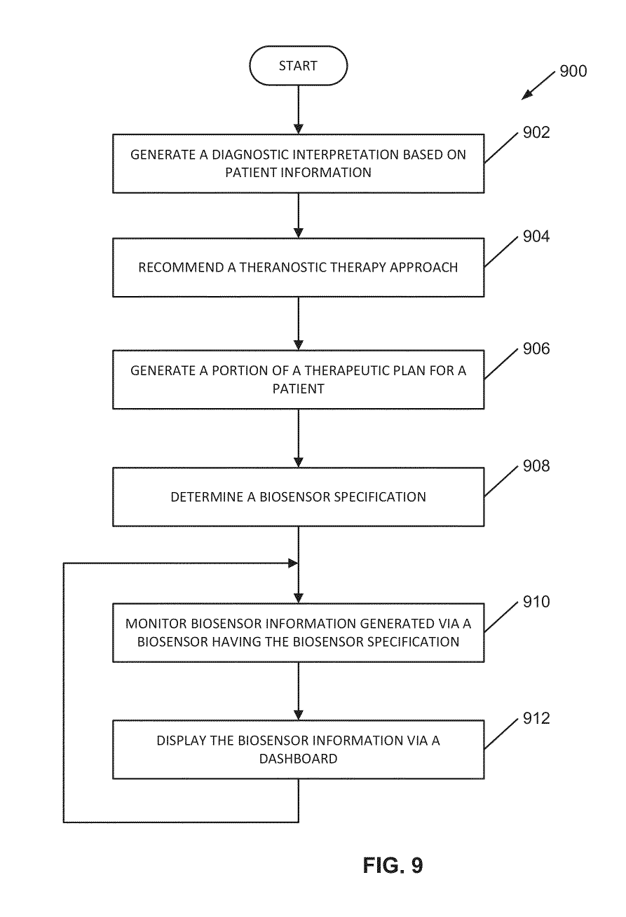

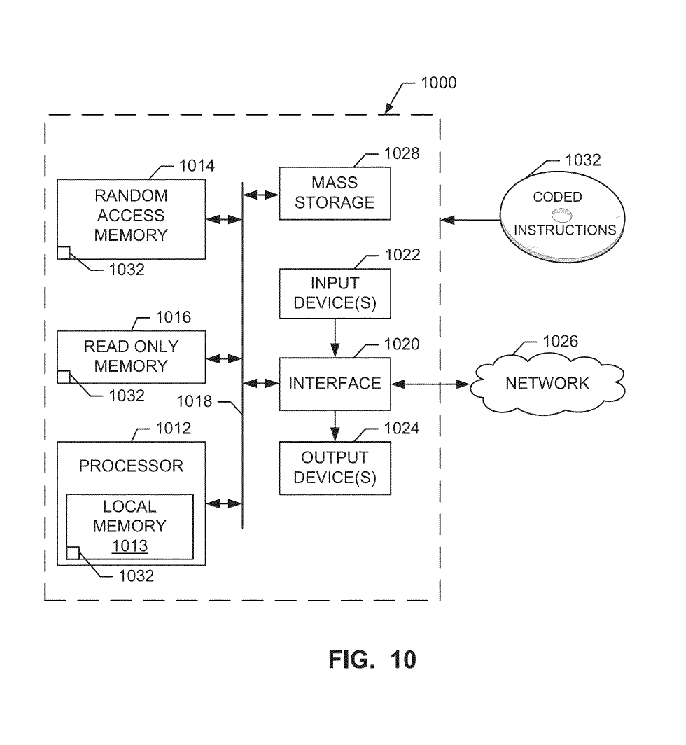

A flowchart representative of example machine readable instructions for implementing the cloud computing system 200 of FIGS. 2-8 is shown in FIG. 9. In this example, the machine readable instructions comprise a program for execution by a processor such as the processor 1012 shown in the example processor platform 1000 discussed below in connection with FIG. 10. The program may be embodied in software stored on a tangible computer readable storage medium such as a CD-ROM, a floppy disk, a hard drive, a digital versatile disk (DVD), a Blu-ray disk, or a memory associated with the processor 1012, but the entire program and/or parts thereof could alternatively be executed by a device other than the processor 1012 and/or embodied in firmware or dedicated hardware. Further, although the example program is described with reference to the flowchart illustrated in FIG. 9, many other methods of implementing the example cloud computing system 200 may alternatively be used. For example, the order of execution of the blocks may be changed, and/or some of the blocks described may be changed, eliminated, or combined.

As mentioned above, the example processes of FIG. 9 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals. As used herein, “tangible computer readable storage medium” and “tangible machine readable storage medium” are used interchangeably. Additionally or alternatively, the example processes of FIG. 9 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable device or disk and to exclude propagating signals. As used herein, when the phrase “at least” is used as the transition term in a preamble of a claim, it is open-ended in the same manner as the term “comprising” is open ended.

The example program 900 of FIG. 9 begins at block 902 by the theranostics advisor 216 generating a diagnostic interpretation based on patient information. For example, the theranostics advisor 216 may process information from the clinical report 290 to generate the diagnostic interpretation. In some examples, the diagnostic interpretation identifies a medical condition of the patient and/or facilitates diagnosis of the medical condition by a clinician.

At block 904, the theranostics advisor 216 recommends a theranostic therapy approach. In some examples, the theranostics advisor 216 recommends the theranostic therapy approach based on the patient information, theranostics information retrieved from the theranostics database 252, biomarker information retrieved via the biomarker database 246 and/or other information. The theranostic therapy approach includes treatment of the patient based on the medical condition of the patient and biomarkers of the patient associated with the medical condition.

At block 906, the theranostics planner 218 generates a portion of a therapeutic plan for the patient. In some examples, the theranostics planner 218 generates the inspection plan 402 and the workflow document 404 to facilitate automation of information flow via the example system 200. For example, the inspection plan 402 may cause the patient monitor 230 to monitor the patient's medical condition via biosensor information and/or generate an alert to one or more clinicians and/or the patient based on the biosensor information. In some examples, the workflow document 404 enables automation of one or more workflow tasks to be performed via the system 200. In some examples, the theranostics planner 218 determines a risk profile for the patient based on the patient information to generate an event schedule. In some examples, the inspection plan 402 is based on the event schedule.

At block 908, the biosensor advisor 220 determines a biosensor specification based on the therapeutic plan. For example, the therapeutic plan may include monitoring a parameter (e.g., a biomarker) of the patient. In some examples, the biosensor advisor 220 determines the biosensor specification associated with the parameter such that biosensors having the biosensor specification are capable of measuring the parameter and/or acquiring information related to the parameter.

In some example, the order service manager 222 processes a clinician order request including the biosensor specification, one or more prescriptions, a tag, and/or other information. In some examples, the application store manager 226 filters biosensors available to the patient via the biosensor marketplace based on the biosensor specification. In some examples, the application store manager 226 communicates an application to the mobile device 258 associated with the patient. The application may be generated (e.g., written) by a third party user and communicated to the system 200 via the third party information system 293. In some examples, the application is then stored in one or more databases in communication with the system 200 (e.g., the content database 256), and the application store manager 226 retrieves the application from the database to communicate the application to the mobile device 258. The application may enable the mobile device 258 to retrieve the tag from a barcode or the NFC device 296, order one or more biosensors via the biosensor marketplace and/or acquire biosensor information from the biosensors once the biosensors 294 are administered.

At block 910, the patient monitor 230 monitors biosensor information generated via a biosensor having the biosensor specification. For example, the patient and/or a caregiver may use the mobile device 258 to order and receive one or more biosensors via the biosensor marketplace. Each of the biosensors available to the patient and/or the caregiver via the biosensor marketplace have the biosensor specification from the clinician order request. Thus, once the biosensors are administered, the patient and/or the caregiver may use the mobile device 258 to acquire the biosensor information generated by the biosensors and communicate the biosensor information to the patient monitor 230. The example patient monitor 230 may then process and/or store the biosensor information. In some examples, the patient monitor 230 determines a state of the biosensors based on the biosensor information. For example, the patient monitor 230 may determine if the biosensors are functioning properly. If the biosensors are not functioning properly, the patient monitor 230 may communicate an alert to the mobile device 258. In some examples, the patient monitor 230 determines if one or more of the parameters of the patient is within a predetermined range of values. If the parameter(s) are outside of the predetermined range of values, the patient monitor 230 may communicate an alert to one or more clinicians. In the illustrated example, at block 912, the dashboard generator 224 displays the biosensor information via a dashboard. The dashboard enables the clinician(s) to monitor the biosensor information. In some examples, based on the biosensor information, the clinician(s) determine an efficacy of the treatment and adjust the therapeutic plan accordingly.

FIG. 10 is a block diagram of an example processor platform 1000 capable of executing the instructions of FIG. 9 to implement the example system of FIGS. 2-8. The processor platform 1000 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 1000 of the illustrated example includes a processor 1012. The processor 1012 of the illustrated example is hardware. For example, the processor 1012 can be implemented by one or more integrated circuits, logic circuits, microprocessors or controllers from any desired family or manufacturer.

The processor 1012 of the illustrated example includes a local memory 1013 (e.g., a cache). The processor 1012 of the illustrated example is in communication with a main memory including a volatile memory 1014 and a non-volatile memory 1016 via a bus 1018. The volatile memory 1014 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1016 may be implemented by flash memory and/or any other desired type of memory device. Access to the main memory 1014, 1016 is controlled by a memory controller.

The processor platform 1000 of the illustrated example also includes an interface circuit 1020. The interface circuit 1020 may be implemented by any type of interface standard, such as an Ethernet interface, a universal serial bus (USB), and/or a PCI express interface.

In the illustrated example, one or more input devices 1022 are connected to the interface circuit 1020. The input device(s) 1022 permit(s) a user to enter data and commands into the processor 1012. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1024 are also connected to the interface circuit 1020 of the illustrated example. The output devices 1024 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 1020 of the illustrated example, thus, typically includes a graphics driver card, a graphics driver chip or a graphics driver processor.

The interface circuit 1020 of the illustrated example also includes a communication device such as a transmitter, a receiver, a transceiver, a modem and/or network interface card to facilitate exchange of data with external machines (e.g., computing devices of any kind) via a network 1026 (e.g., an Ethernet connection, a digital subscriber line (DSL), a telephone line, coaxial cable, a cellular telephone system, etc.).

The processor platform 1000 of the illustrated example also includes one or more mass storage devices 1028 for storing software and/or data. Examples of such mass storage devices 1028 include floppy disk drives, hard drive disks, compact disk drives, Blu-ray disk drives, RAID systems, and digital versatile disk (DVD) drives.

The coded instructions 1032 of FIG. 9 may be stored in the mass storage device 1028, in the volatile memory 1014, in the non-volatile memory 1016, and/or on a removable tangible computer readable storage medium such as a CD or DVD.

From the foregoing, it will be appreciated that the above disclosed methods, apparatus and articles of manufacture integrate theranostics into a continuum of care of a patient. The examples disclosed herein assist clinicians diagnose a patient's medical condition, develop a therapeutic plan to treat the medical condition, monitor an efficacy of the treatment, and monitor indications of relapse of the medical condition. For example, the examples disclosed herein facilitate development of the therapeutic plan by generated diagnostic interpretations of patient information and recommending theranostic therapy approaches for treating the patient's medical condition. The examples disclosed herein also recommend biosensor specifications and/or biosensors associated with biomarkers of the patient relevant to the patient's medical condition. The examples disclosed herein also enable clinicians employing different clinical information systems at different stages of the continuum of care to view and/or contribute information related to the patient, the therapeutic plan, the treatment, and the biosensors via a cloud computing system. Some examples disclosed herein enable the patient and/or a caregiver of the patient to order the biosensors and communicate information generated by the biosensors to the clinicians via the cloud computing system to enable the clinicians to monitor the patient and, thus, an efficacy of the treatment.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A system, comprising:
a theranostics advisor to analyze patient information and recommend a theranostic therapy approach based on the patient information;
a theranostics planner to generate a portion of a therapeutic plan for the patient based on the theranostic therapy approach;
a biosensor advisor to recommend a biosensor specification based on the therapeutic plan;
a patient monitor to receive biosensor information from a biosensor having the biosensor specification;
a dashboard generator to generate a dashboard to display the biosensor information; and
a processor to implement at least one of the theranostics advisor, the theranostics planner, the biosensor advisor, the patient monitor or the dashboard generator.

2. The system of claim 1 further comprising an order service manager to process an order request including the biosensor specification.

3. The system of claim 2, wherein the order service manager is to generate a tag, the tag to be used by at least one of the patient or a caregiver of the patient to access the system via a mobile device.

4. The system of claim 1, further comprising an application store manager, the application store manager to enable at least one of the patient or the caregiver of the patient to order the biosensor via a mobile device associated with the patient.

5. The system of claim 4, wherein the application store manager is to filter biosensors to be available to at least one of the patient or the caregiver of the patient to order via a biosensor marketplace based on the biosensor specification.

6. The system of claim 4, wherein the application store manager is to publish product information via the mobile device, the product information received from a third party information system in communication with the system.

7. The system of claim 1 further comprising a portal manager to enable a third party user to store the biosensor specification in a database in communication with the biosensor advisor.

8. The system of claim 1, wherein the theranostics advisor is to generate a diagnostic interpretation based on the patient information.

9. A method, comprising:
generating a diagnostic interpretation based on patient information;
recommending a theranostic therapy approach based on the diagnostic interpretation, the patient information and theranostics information;
generating a portion of a therapeutic plan for a patient based on the theranostic therapy approach;
determining a parameter of the patient to monitor based on the therapeutic plan; and
recommending a biosensor specification based on the parameter.

10. The method of claim 9, wherein generating the portion of the therapeutic plan comprises determining an inspection plan for the patient.

11. The method of claim 9 further comprising processing biosensor information communicated from a mobile device associated with the patient, the biosensor information generated via a biosensor having the biosensor specification.

12. The method of claim 11 further comprising generating a dashboard to display the biosensor information.

13. The method of claim 11 further comprising communicating an alert to a clinical information system based on the biosensor information.

14. The method of claim 11, further comprising determining a state of the biosensor based on the biosensor information and communicating an alert to the mobile device based on the state.

15. The method of claim 11 further comprising communicating an application to the mobile device, the application to enable the mobile device to acquire the biosensor information from the biosensor.

16. A tangible machine readable storage medium comprising instructions that, when executed, cause a machine to at least:
suggest a theranostic therapy approach based on a clinical report associated with a patient;
generate an inspection plan for the patient based on the clinical report and the theranostic therapy approach;
determine a biosensor specification based on the inspection plan; and
monitor biosensor information generated via a biosensor employed by the patient, the biosensor having the biosensor specification.

17. The tangible machine readable storage medium of claim 16, wherein the instructions, when executed, further cause the machine to display the biosensor information via a dashboard.

18. The tangible machine readable storage medium of claim 16, wherein the instructions, when executed, further cause the machine to determine a risk profile of the patient based on the clinical report.

19. The tangible machine readable storage medium of claim 18, wherein the instructions, when executed, further cause the machine to generate an event schedule based on the risk profile, wherein the inspection plan is to be based on the event schedule.

20. The tangible machine readable storage medium of claim 16, wherein the instructions, when executed, further cause the machine to process a clinician order request including the biosensor specification and a prescription.
